(19) United States
(12) Patent Application Publication
(10) Pub. No.: US 2025/0390833 A1
(43) Pub. Date: Dec. 25, 2025

(54) SYSTEM AND METHOD FOR FORECASTING RESOURCE ALLOCATIONS

(71) Applicant: Walmart Apollo, LLC, Bentonville, AR (US)

(72) Inventors: Ankur Lahiri, Hulimavu (IN); Dongxuan Zhang, McKinney, TX (US); Shuohao Wu, Bentonville, AR (US); Xiaoxu Zhang, Santa Clara, CA (US); Sai Praharsha Devalla, Bentonville, AR (US)

(21) Appl. No.: 18/749,321

(22) Filed: Jun. 20, 2024

(51) Int. Cl. G06Q 10/0835; G06Q 10/0631; G06Q 10/083

(52) U.S. Cl. CPC G06Q 10/08355; G06Q 10/06315; G06Q 10/0838

(57) ABSTRACT

System and methods for forecasting resource allocations are disclosed. In some embodiments, a disclosed method includes: storing, in a database, historical data associated with a transportation carrier, receiving, from the database, journey data associated with the transportation carrier, parsing and extracting, from the journey data, a plurality of segments, training a plurality of models based on the historical data, identifying a best model from the plurality of models based on performance metrics over a predetermined period of time, and applying the best model to the plurality of segments to identify an optimal route associated with the transportation carrier.

### TECHNICAL FIELD

This application relates generally to forecasting resource allocations and, more particularly, to systems and methods for forecasting resource allocations associated with transportation.

### BACKGROUND

Efficient resource allocation is crucial in the goods and services industry, particularly for transporting goods between distribution centers and point of sale locations. Transportation operators are often faced with unpredictable schedules and varying demands. Transportation operator must manage their time effectively to meet delivery deadlines, optimize routes, and ensure vehicle maintenance, all while adhering to regulatory requirements.

Conventional methods for resource allocation often rely on manual planning or basic automated systems that lack the ability to adapt to real-time changes or future disruptions. These conventional methods can lead to inefficiencies, such as underutilized capacity, missed delivery windows, and increased operating costs.

One critical aspect of resource allocation for transporting of goods is mileage forecasting. Accurate mileage predictions are essential for planning fuel stops, estimating travel times, and determining optimal routes. However, existing mileage forecasting methods often fall short in accuracy and adaptability, leading to suboptimal resource allocation decisions.

### SUMMARY

The embodiments described herein are directed to systems and methods for forecasting resource allocations.

In various embodiments, a system is disclosed. The system includes a database storing historical data associated with a transportation carrier, a computing device comprising at least one processor in communication with the database, the computing device being configured to receive, from the database, journey data associated with the transportation carrier, parse and extract, from the journey data, a plurality of segments, train a plurality of models based on the historical data, identify a best model from the plurality of models based on performance metrics over a predetermined period of time, and apply the best model to the plurality of segments to identify an optimal route associated with the transportation carrier.

In some embodiments, the plurality of segments includes an inbound segment, an outbound segment, and an empty segment. The empty segment is associated with the transportation carrier being devoid of goods.

In some embodiments, the processor is further configured to identify an origination point for each of segment of the plurality of segments.

In some embodiments, the processor is further configured to extract a route from the journey data, and segment the route to identify the plurality of segments.

In some embodiments, the processor is further configured to train, in parallel, the plurality of models, identify the best model of the plurality of models, and use the best model to generate forecast parameters associated with the transportation carrier.

In some embodiments, the processor is further configured to detect an anomaly from the journey data based on comparing one or more forecasted parameters to a predetermined threshold, and provide a recommended route adjustment based on the anomaly.

In some embodiments, the processor is further configured to train, in parallel, a plurality of adjustment models, the adjustment models configured to incorporate one or more adjustment factors, identify a best adjustment model of the plurality of adjustment models, and use the best adjustment model to generate adjusted forecast parameters associated with the transportation carrier during a specific period of time.

In some embodiments, the processor is further configured to apply a baseline fix to the best model to account to volatility.

In some embodiments, the processor is further configured to identify routes between a domicile of the transportation carrier and a first location, and apply the best model to the historical data to identify a subset of the routes, the subset of the routes having minimized transportation distances between the domicile and the first location.

In various embodiments, a computer implemented method is disclosed. The computer implemented method includes storing, in a database, historical data associated with a transportation carrier, receiving, from the database, journey data associated with the transportation carrier, parsing and extracting, from the journey data, a plurality of segments, training a plurality of models based on the historical data, identifying a best model from the plurality of models based on performance metrics over a predetermined period of time, and applying the best model to the plurality of segments to identify an optimal route associated with the transportation carrier.

In some embodiments, the plurality of segments includes an inbound segment, an outbound segment, and an empty segment. The empty segment is associated with the transportation carrier being devoid of goods.

In some embodiments, the method further includes identifying an origination point for each of segment of the plurality of segments.

In some embodiments, the method further includes extracting a route from the journey data, and segmenting the route to identify the plurality of segments.

In some embodiments, the method further includes training, in parallel, the plurality of models, identifying the best model of the plurality of models, and using the best model, generating forecast parameters associated with the transportation carrier.

In some embodiments, the method further includes detecting an anomaly from the journey data based on comparing one or more forecasted parameters to a predetermined threshold, and providing a recommended route adjustment based on the anomaly.

In some embodiments, the method further includes training, in parallel, a plurality of adjustment models, the adjustment models configured to incorporate one or more adjustment factors, identifying a best adjustment model of the plurality of adjustment models, and using the best adjustment model, generating adjusted forecast parameters associated with the transportation carrier during a specific period of time.

In some embodiments, the method further includes identifying routes between a domicile of the transportation carrier and a first location, and applying the best model to the historical data to identify a subset of the routes, the subset of the routes having minimized transportation distances between the domicile and the first location.

In various embodiments, a non-transitory computer readable medium having instructions stored thereon is disclosed. The instructions, when executed by at least one processor, cause at least one device to perform operations including storing, in a database, historical data associated with a transportation carrier, receiving, from the database, journey data associated with the transportation carrier, parsing and extracting, from the journey data, a plurality of segments, training a plurality of models based on the historical data, identifying a best model from the plurality of models based on performance metrics over a predetermined period of time, and applying the best model to the plurality of segments to identify an optimal route associated with the transportation carrier.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to forecast resource allocations, in accordance with some embodiments of the present teaching.

FIG. 2 is a block diagram of a resource allocation forecaster, in accordance with some embodiments of the present teaching.

FIG. 3 is a flow diagram of a system for forecasting resource allocations, in accordance with some embodiments of the present teaching.

FIG. 4 is a flow diagram of an exemplary model for forecasting resource allocations using the resource allocation forecaster of FIG. 2, in accordance with some embodiments of the present teaching.

FIG. 5 is a flow diagram of a forecasting module of the system for forecasting resource allocations, in accordance with some embodiments of the present teaching.

FIG. 6 is a flow diagram of a forecasting module of the system for forecasting resource allocations, in accordance with some embodiments of the present teaching.

FIG. 7 is a flow diagram of a detecting anomalies associated with forecasting resource allocations, in accordance with some embodiments of the present teaching.

FIG. 8 is a flow diagram of an exemplary model for forecasting resource allocations using the resource allocation forecaster of FIG. 2, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

The present disclosure provides systems and methods for forecasting resource allocations. In some embodiments, the systems and methods utilize models (e.g., machine learning models) to forecast resource allocations based on predicted usage. For example, the systems and method provided herein may use historical data to determine future resource allocations. In some embodiments, the systems and methods provided herein including reconstructing journeys of a transportation carrier to determine optimal routes. For example, a transportation carrier's journey may include an inbound route, an outbound route, and an empty route. One or more models may be used to optimize the transportation carrier's journey to minimize the empty routes.

In some embodiments, the systems and methods provided herein breakdown each transportation carrier's journey and reconstructs the journey to provide an optimal route. An optimal route may be defined as the route with the least number of miles, the least number of miles driving while empty (e.g., no cargo or goods), and/or the least number of miles prior to beginning route.

In some embodiments, the systems and methods provided herein provide a forecasting of loads and length of haul (LOH) for one or more transportation carriers. The systems and methods provided herein may utilize a plurality of models to forecast loads and LOH to account for recent volatility and forecast future demand. In some embodiments, the systems and methods provided herein run a plurality of models and select the best performing model based on one or more performance metrics (e.g., robustness, consistency, and accuracy). For example, each model may generate a forecast of routes, which may be compared to the actual performed routes to determine accuracy of the models.

In some embodiments, the systems and methods provided herein provide a forecasting of outbound routes. For example, one or more models may be used to optimize the number of goods (e.g., cases per trailer (CPT))) that a transportation carrier can transport between locations. The locations may include distribution centers, warehouses, retail stores, or other locations that provide goods. In some embodiments, the systems and methods provided herein including preforming modeling adjustments to account for variances in the CPT based on, for example, seasonal items, large items, holidays, etc. In some embodiments, the systems and methods provided herein utilize a first set of models to forecast journeys for non-holiday or non-seasonal time periods and utilize a second set of models to forecast journeys for holiday and/or season time periods.

In some embodiments, one or more models are used to allocate resources dynamically. For example, a transportation carrier may have a domicile at a location far from a distribution center. Using one or more models, the system provided herein may re-allocate the transportation carrier to a different distribution center to optimize the transportation carrier's route and reduce empty miles.

In some embodiments, the systems and methods provided herein utilizes one or more models to detect anomalies in forecasted routes. For example, one or more models may be used to detect an anomaly, such as shortage of transportation carriers, inefficient driving by the transportation carrier(s), etc. and may adjust one or more routes based on the detected anomaly.

One goal of the present teaching is to forecast resource allocations to optimize journeys of transportation carriers. In some embodiments, a disclosed system utilizes one or more models to reconstruct journeys associated with a transportation carrier, forecast routes of the transportation carrier, and allocation resource dynamically.

Furthermore, in the following, various embodiments are described with respect to methods and systems for analyzing contextual data. In some embodiments, a disclosed method includes: storing, in a database, historical data associated with a transportation carrier, receiving, from the database, journey data associated with the transportation carrier, parsing and extracting, from the journey data, a plurality of segments, training a plurality of models based on the historical data, identifying a best model from the plurality of models based on performance metrics over a predetermined period of time, and applying the best model to the plurality of segments to identify an optimal route associated with the transportation carrier.

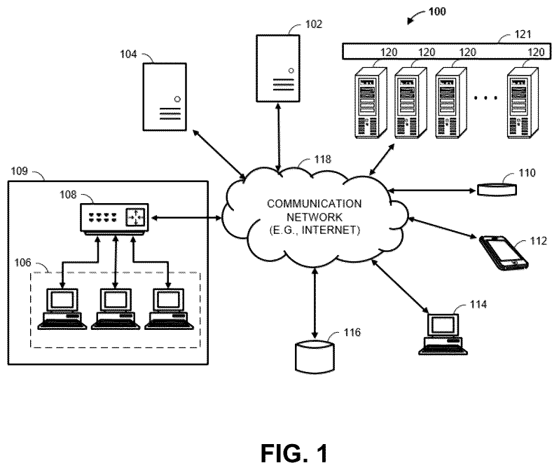

Turning to the drawings, FIG. 1 is a network environment 100 configured to forecast resource allocations, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, resource forecaster (“forecaster”) 102 (e.g., a server, such as an application server), a web server 104, a cloud-based engine 121 including one or more processing devices 120, workstation(s) 106, a database 116, and one or more user computing devices 110, 112, 114 operatively coupled over the network 118. The forecaster 102, the web server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the forecaster 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the forecaster 102.

In some examples, each of the multiple user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more retailer websites providing one or more products or services. In some examples, the forecaster 102, the processing devices 120, and/or the web server 104 are operated by a retailer. The multiple user computing devices 110, 112, 114 may be operated by customers or advertisers associated with the retailer websites. In some examples, the processing devices 120 are operated by a third party (e.g., a cloud-computing provider). In some embodiments, forecaster 102 is configured to communicate with a digital assistant (e.g., digital assistant 250). Digital assistant 250 may be implemented into a mobile device and accessed via user interface 205.

The workstation(s) 106 are operably coupled to the communication network 118 via a router (or switch) 108. The workstation(s) 106 and/or the router 108 may be located at a store 109 of a retailer, for example. The workstation(s) 106 can communicate with the forecaster 102 over the communication network 118. The workstation(s) 106 may send data to, and receive data from, the forecaster 102. For example, the workstation(s) 106 may transmit data identifying items purchased by a customer at the store 109 to the forecaster 102.

Although FIG. 1 illustrates three user computing devices 110, 112, 114, the network environment 100 can include any number of user computing devices 110, 112, 114. Similarly, the network environment 100 can include any number of the forecaster 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the web server 104 over the communication network 118. For example, each of the multiple computing devices 110, 112, 114 may be operable to view, access, and interact with a website, such as a retailer's website hosted by the web server 104. The web server 104 may transmit user session data related to a customer's activity (e.g., interactions) on the website.

In some examples, a customer may operate one of the user computing devices 110, 112, 114 to initiate a web browser that is directed to the website hosted by the web server 104. The customer may, via the web browser, view a user interface for viewing and interacting one or more applications. The one or more applications may allow a user to view, interact with, and/or forecast resource allocations. In some embodiments, the applications capture these activities as user session data, and transmit the user session data to the forecaster 102 over the communication network 118.

In some embodiments, the web server 104 transmits a request to the forecaster 102, e.g. based on a user's request for a forecast of resource allocations. For example, the request may be sent based on a user providing an input into an application for forecasting resource allocations. The request may be sent standalone or together with other related data of the application (e.g., a website). In some examples, the request may carry or indicate user data.

In some examples, the forecaster 102 may execute one or more models (e.g., algorithms), such as a mathematical models, machine learning model, deep learning model, statistical model, etc., to provide an output to the user. The output may be presented on the user interface and/or may include a one or more optimal routes associated with a transportation carrier.

The forecaster 102 is further operable to communicate with the database 116 over the communication network 118. For example, the forecaster 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the forecaster 102, in some examples, the database 116 can be a local storage device, such as a hard drive, a non-volatile memory, or a USB stick. The forecaster 102 may store historical data, business metrics, user data, or data associated with one or more routes or transportation carriers. Database 116 may be coupled to a computing device. For example, database 116 may be coupled to one or more user computing devices 110, 112, 114 via communication network 118.

In some embodiments, the web server 104 transmits a model training request to the forecaster 102. Upon the model training request, the forecaster 102 may retrieve, e.g. from the database 116, historical data associated with previous routes of one or more transportation carriers. The forecaster 102 may train one or more models using the historical data. The one or more models may be trained to generate outputs for forecaster 102. The one or more models may be trained to generate outputs for forecaster 102 based on a request from a user. In some embodiments, the one or more models are configured to receive feedback from the user to refine or retrain the one or more models. For example, a customer may transmit a request to forecaster 102. Forecaster 102 may provide one or more routes or journeys to the user. The user may transmit a subsequent request to forecaster 102 including adjustments to the one or more routes or journeys. Forecaster 102 may provide updated or refined routes and/or may refine one or more models based on the subsequent request of the customer.

In some embodiments, the outputs from the model may be used to refine and train the model. For example, one or more models may be trained using historical data (e.g., previous routes) and may generate optimal routes. Forecaster 102 may receive adjustment or refinement data associated with whether the user made or requested additional adjustments or refinements to the generated routes. The adjustment data may be inputted into the one or more models such that the one or more models compares the adjustments to the generated routes to generate a comparison value. The greater the comparison value the greater the deviation the adjustment is from the generated route. In other words, the greater the comparison value, the less accurate the one or more models are. In some embodiments, the comparison value may be inputted into the one or more models to refine the one or more models to make the one or more models more accurate.

The models, when executed by the forecaster 102, allow the forecaster 102 to generate one or more optimized routes. In some examples, the forecaster 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, the forecaster 102 may generate a plurality of routes for one or more transportation carriers to optimize transportation of cargo or goods.

In some embodiments, forecaster 102 is configured to forecast resource allocations. For example, forecaster 102 may provide a plurality of optimized journeys to minimize the amount of empty and/or inefficient miles. Forecaster 102 may generate a plurality of optimized routes based on a user's request.

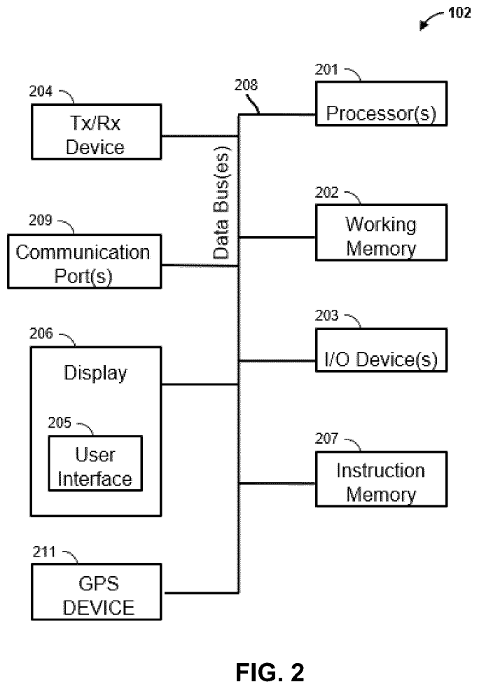

FIG. 2 illustrates a block diagram of a resource forecaster, e.g. the forecaster 102 of FIG. 1, in accordance with some embodiments of the present teaching. In some embodiments, each of the forecaster 102, the web server 104, the multiple user computing devices 110, 112, 114, and the one or more processing devices 120 in FIG. 1 may include the features shown in FIG. 2. Although FIG. 2 is described with respect to certain components shown therein, it will be appreciated that the elements of the forecaster 102 can be combined, omitted, and/or replicated. In addition, it will be appreciated that additional elements other than those illustrated in FIG. 2 can be added to the forecaster 102.

As shown in FIG. 2, the forecaster 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the forecaster 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the forecaster 102 can include a single memory unit configured to operate as both instruction memory and working memory. Further, although embodiments are discussed herein including non-volatile memory, it will be appreciated that computing device 110, 112, 114 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the forecaster 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the forecaster 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the forecaster 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the forecaster 102 and/or the web server 104. For example, the user interface 205 can be a user interface for an application of a network environment operator that allows a user to view and interact with one or more routes generated by forecaster 102. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the forecaster 102 may determine a local geographical area (e.g., town, city, state, etc.) of its position.

In some embodiments, the forecaster 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software.

In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

The network environment 100 further includes one or more model training systems that are communicatively coupled with at least one or more model database maintaining trained models and one or more training data databases (e.g., database 116) that stores relevant training data to train and/or retrain the one or more models used by the forecaster 102. The model training system includes one or more model training servers or managers, which are implemented through one or more computing systems, servers, computers, processor and/or other such systems communicatively coupled with one or more of the distributed communication networks 118, and are configured to build and/or train the machine learning models. In some implementations, the model training system includes multiple sub-model training systems each associated with one or more of the different machine learning models.

The training data database stores and updates relevant training data. The training data may include historical data of one or more routes of a plurality of transportation carriers. Further, the training data includes historic journeys, typically for one or more years. The training data additionally includes historic information about different information supplied to and/or accessed by different users corresponding to thousands or more routes from hundreds of different suppliers and/or manufactures from multiple different retail stores distributed over multiple different geographic areas. Further, the training systems is configured to receive feedback information at least through the graphical user interface. This feedback can include changes in settings, requests for other information, clicks to other information, clicks to more detailed information, tagging of information for another potential recipient, indications of like and/or dislike of information, comments, actions indicating a disregard of types of information, searches performed, subsequent use of information provided, subsequent actions taken by recipients following access to different information, and other such feedback. The training system utilizes the feedback information to repeatedly over time retrain the models to repeatedly provide over time retrained models to provide more accurate recommended products and prioritization of the recommended products to the customer. This allows the models to be refined per customer to provide recommended products that the customer has a high likelihood of purchasing.

The training data databases (e.g., database 116) can be local to the model training system, remote and accessible over one or more of the communication networks 118 or a combination of local and distributed. The model training system uses the relevant machine learning data to train the machine learning models. In some embodiments, one or more training processes are similar to the process performed by one or more models after having been trained, but can be trained with multiple sets of training data (e.g., some real and some simulated or synthetic for training). Predictions are compared to actuals to ensure that the set of models are operating with a certain threshold confidence. Further, the model training system is configured to receive feedback information through the graphical user interface corresponding to actions by the recipient interfacing with the graphical user interface.

The above and below description includes descriptions of embodiments implementing and/or utilizing trained machine learning models and/or neural networks. For example, the systems and methods described herein may utilize one or more natural language processing (NLP) models to process spoken language. In some embodiments, the neural network, machine learning models and/or machine learning algorithms may include, but are not limited to, Large Language Models (LLM), Heuristics, Univariate based techniques, Multivariate, control limit, isolation forest and LOF-ensembles, deep learning models such as LSTM-based autoencoders, variational autoencoders, deep stacking networks (DSN), Tensor deep stacking networks, convolutional neural network, probabilistic neural network, autoencoder or Diabolo network, linear regression, support vector machine, Naïve Bayes, logistic regression, K-Nearest Neighbors (kNN), decision trees, random forest, gradient boosted decision trees (GBDT), K-Means Clustering, hierarchical clustering, DBSCAN clustering, principal component analysis (PCA), and/or other such models, networks and/or algorithms.

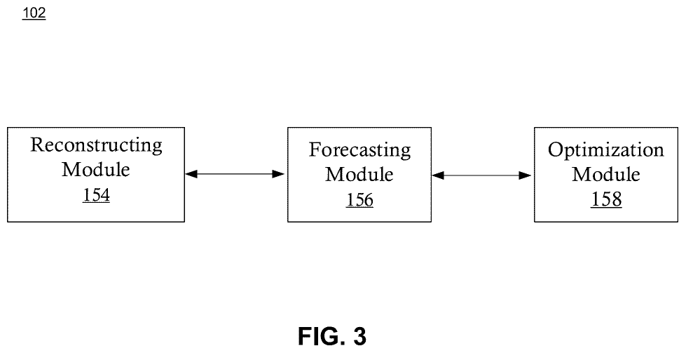

FIG. 3 is a block diagram of forecaster 102, in accordance with some embodiments of the present teaching. Forecaster 102 may be configured to forecast journeys planned for one or more transportation carriers. As indicated in FIG. 3, forecaster 102 may include reconstructing module 154, forecasting module 156, and optimization module 158. Reconstructing module 154 may be configured to reconstruct one or more journeys of a transportation carrier to determine which segments of a route are empty segments. Reconstructing module 154 may breakdown each planned journey or previously occurred journey into segments. For example, reconstructing module 154 may breakdown historical journeys (e.g., previously occurred journeys). Reducing empty segments of a journey is crucial to reduce resource waste and optimize journeys. In some embodiments, reconstructing module 154 is configured to reconstruct one or more journeys to reduce the number of empty segments in a journey.

Forecasting module 156 may be configured to forecast loads and LOH over a predetermined period of time, such as a year. In some embodiments, forecasting module 156 utilizes a plurality of models trained over a predetermined period of time. Forecasting module 156 may identify the best performing model of the plurality of models (e.g., based on performance metrics) to forecast impacts on one or more journeys. Impacts may include seasonal time periods, holidays, or transportation of large cargo (e.g., cargo that is large in size and volume), which reduces the overall amount of goods that can be transported.

Optimization module 158 may be configured to analyze historical journeys and allocate resources dynamically. For example, optimization module 158 may analyze journey segments between distribution centers and domiciles to determine the number of empty miles driven by a transportation carrier. Optimization module 158, using one or more models, may reduce the number of empty miles by adjusting routes based on historical journeys.

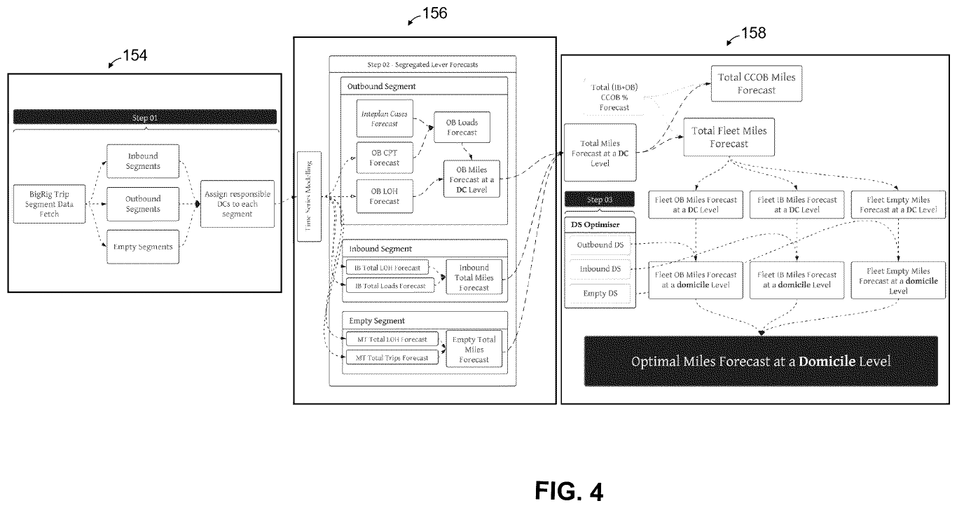

Referring to FIG. 4, an exemplary method of forecaster 102 is illustrated. Forecaster 102 may include reconstructing module 154. Reconstructing module 154 may be configured to segment routes into inbound segments, outbound segments, and empty segments. For example, reconstructing module 154 may fetch segment data from a database, such as database 116. Reconstructing module 154 may parse historical or completed journeys to determine inbound segments, outbound segments, and empty segments.

In some embodiments, reconstructing module 154 assigns a distribution center to each parsed segment. For example, for each parsed inbound, outbound, and empty segment, reconstructing module 154 may assign a distribution center (DC). In some embodiments, for outbound segments, the origin location (DC or store) is the assigned DC. For empty segments, the origin location is assigned as the DC. For inbound segments, the destination DC is assigned as the DC. In some embodiments, the DC assigned to a domicile (e.g., the location where the transportation carrier resides) is the DC that the transportation carrier performs the most work for. Assignment of DCs to each segment may assist with generating nodes for each segment to generate a journey for each transportation carrier, where the segments comprise the journey.

Each journey may include an inbound segment, an outbound segment, and an empty segment. In some embodiments, each segment has endpoints at a node. The node may be a distribution center, domicile, or a retail store. In some embodiments, each node can have three segments-inbound segment, outbound segment, and empty segment. Determining which segments are inbound, outbound, and empty is critical to reducing resource waste and inefficiencies.

A transportation carrier may originate at a domicile and drive an empty segment to a distribution center to load cargo and goods into the transportation carrier. The transportation may depart the distribution center and drive an outbound segment to a retailer store. The transportation carrier may depart the retailer store to another distribution center and drive an inbound segment. In some embodiments, segments where the transportation carrier is empty or not transporting goods is tagged as an empty segment, segments where the transportation carrier originates at a distribution center or a retailer store and is delivery to a retailer store is tagged as an outbound segment, and all other segments that are not empty segments or outbound segments are tagged as inbound segments.

In some embodiments, reconstructing module 154 transmits the parsed segments and assigned DCs to forecasting module 156. Forecasting module 156 may utilize one or more models on each of the outbound segments, inbound segments, and empty segments. For example, forecasting module 156 may forecast one or more parameters for each parsed segment. The parameters may include cases per trailer (CPT), length of haul (LOH), loads, and miles. In some embodiments, forecasting module 156 utilizes one or more time series models to generate forecasted parameters.

With continued reference to FIG. 4, the forecasted parameters generated by forecasting module 156 may be transmitted to optimization module 158. Optimization module 158 may be configured to receive the forecasted parameters (e.g., the forecasted miles) and generate total forecasted miles for a plurality of transportation carriers (e.g., fleet). In some embodiments, optimization module 158 generates optimized distribution routes. Optimized distribution routes may minimize transportation distance (e.g., the miles or empty miles) based on domiciles. Optimization module 158 may utilizes one or more models to generate optimized routes based on domicile locations to minimize empty segment miles and overall miles of one or more transportation carriers.

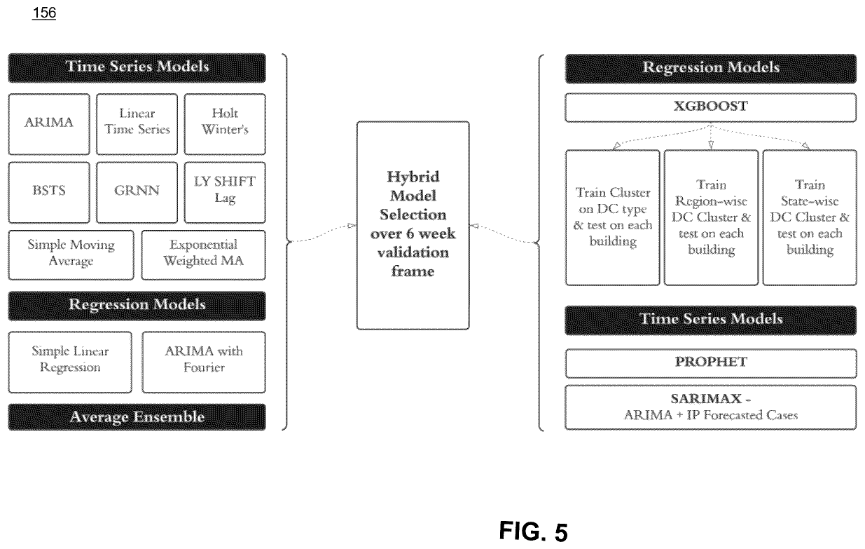

FIG. 5 illustrates a methodology of forecasting module 156. Forecasting module may utilize one or more models to generate forecasted parameters for each segment parsed by reconstructing module 154. In some embodiments, forecasting module 156 utilizes a plurality of parallel models trained using historical data over a predetermined period of time. The predetermined period of time may be between one week and three years, three weeks and one year, six weeks to six months, or greater than three years. In some embodiments, the predetermined period of time is six weeks. Upon training the plurality of models, the best performing model is identified and used to forecast one or more parameters over a predetermined forecasting period. The predetermined forecasting period may be one week, six weeks, 18 weeks, 26 weeks, 52 weeks, or greater than 52 weeks.

In some embodiments, a baseline fix is applied to account for recent volatility. For example, due to the recent volatility and increases in demand for transportation carriers, a baseline fix is implemented for the loads and LOH forecast to reflect the latest trend of the changes. In some embodiments, forecaster 102 is configured to take the recent four weeks average and compare with the 52 weeks out forecast average baseline. If the forecast average baseline is 15% below the most recent average, then forecaster 102 adjusts up the forecast average baseline.

Forecasting module 156 may use one or more time series models, regression models, or hybrid models. In some embodiments, forecasting module 156 uses one or more models including Autoregressive Integrated Moving Average (ARIMA), Linear Time Series, Holt Winter's, Bayesian Structural Time Series (BSTS), General Regression Neural Network (GRNN), LY SHIFT Lag, Simple Moving Average, Exponential Weighted Moving Average, Simple Linear Regression, ARIMA with Fourier, XGBoost, Prophet, and/or Seasonal Auto-Regressive Integrated Moving Average with Exogenous factors (SARIMAX). Forecasting module 156 may be configured to selected one of the plurality of models based on robustness, consistency, and accuracy of the models. In some embodiments, the best performing model is selected based on separate time series models being applied to individual DC chambers (e.g., category of goods).

In some embodiments, forecaster 102 (e.g., forecasting module 156) analyzes the past eight weeks actuals as validation period and compares. Forecasting module 156 may compare all the models against the actuals to identify the model having the highest average accuracy across those eight weeks. Forecasting module 156 may select the identified model as the model for prediction that specific week. In some embodiments, out of time validation period is the last eight weeks. Forecasting module 156 may identify the best model with the lowest MAPE (mean absolute percentage error) over the validation period.

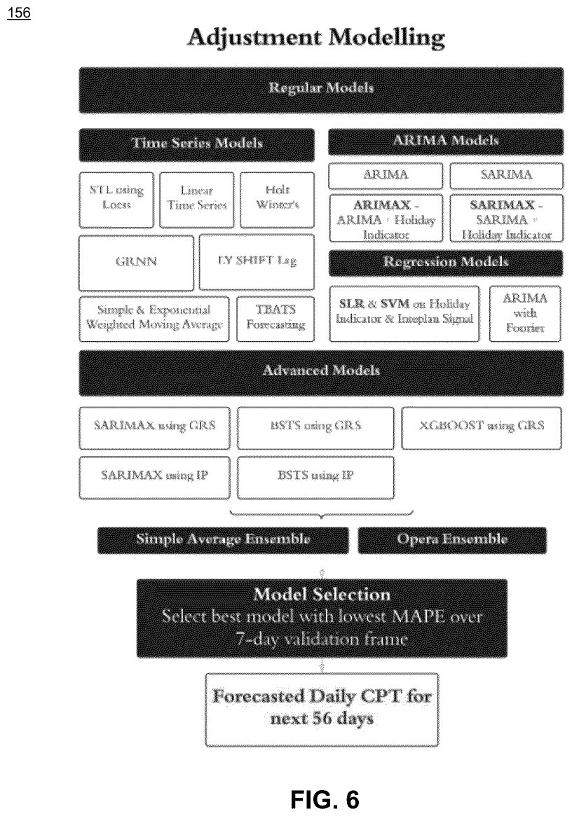

Referring to FIG. 6, forecasting module 156 is configured to utilize one or more adjustment models to account for variances due to seasonal or holiday forecasting. For example, during seasonal time periods or holidays, different cargos and goods are in high demand (e.g., Christmas trees during November-December). In some embodiments, the cases per trailer (CPT) is impacted based on different goods and large cargo (e.g., large Christmas trees). Forecasting module 156 may perform modeling adjustment of the selected model. For example, forecasting module 156 may cluster large, seasonal items, which causes the CPT to decrease due to decreased space available.

In some embodiments, forecasting module 156 incorporates large item GRS (global replenishment system) demand signals into the selected model. GRS may contain item-level demand signals going Outbound from distribution centers and may be used to track the demand of large items in the recent future.

Forecasting module 156 may then adjust the model based on the large item GRS demand signals. In some embodiments, forecasting module 156 performs the modeling adjustment a few weeks (e.g., 3-4 weeks) in advance of the variance (e.g., season time period or holiday). In some embodiments, forecasting module 156 adjusts one or more models and selects the best adjusted model based on the lowest mean average percentage error (MAPE) over a predetermined time period (e.g., one week). In some embodiments, forecasting module 156 forecasts daily CPTs over the next eight weeks.

In some embodiments, forecasting module 156 using one or more of the selected model and the adjusted model generates forecast parameters based on the parse segments from reconstructing module 154. The generated forecast parameters (e.g., forecasted loads and LOH) may be used by optimization module 158 to generate optimal routes to reduce overall empty segments of a route or journey. Optimization module 158 may be configured to generate optimal routes based on the forecasted parameters. For example, optimization module 158 may generate one or more routes between DC and domiciles associated with the transportation carrier based on the forecasted to minimize empty miles. Forecasting module 156 may be configured to utilize the forecasted number of loads for outbound, inbound, and empty segments to minimize the empty route. Forecaster 102 may be configured to identify the optimized route to combine all the loads together to minimize the empty route taken.

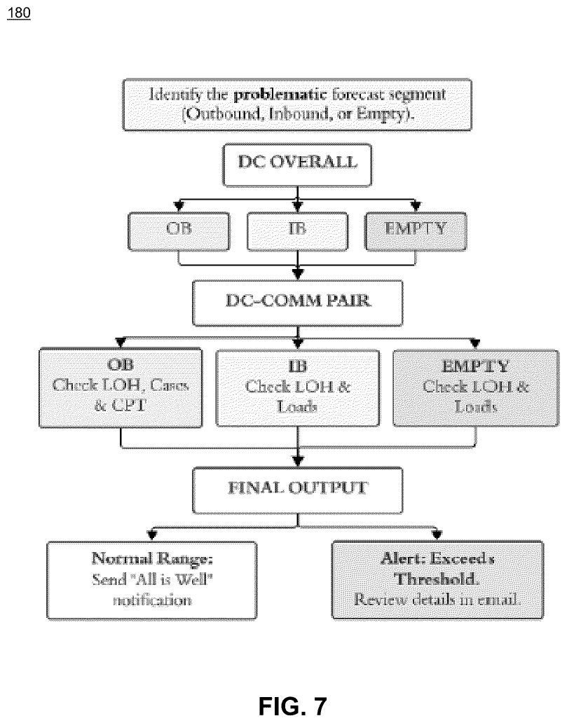

Referring to FIG. 7, forecaster 102 may include anomaly detector or detector 180. Detector 180 may be configured to detect inefficiencies in forecasted routes. For example, detector 180 may identify a segment that has a reduced supply of transportation carriers compared to the demand and may provide recommendations for adjustment (e.g., increasing the number of transportation carriers). In some embodiments, detector 180 is run daily to detect anomalies in scheduled routes.

Detector 180 may be configured to identify a parsed segment having an anomaly. In some embodiments, detector 180 compares each forecasted parameter to one or more threshold. Upon one or more forecasted parameters exceeding a predetermined threshold, detector 180 may identify the segment, route, or journey as an anomaly. In some embodiments, detector 180, using one or more models, provides one or more recommendations to address the anomaly. Detector 190 may be configured to compare the immediate next week's forecast with the past week's actuals. If any of the forecasted loads (e.g., LOH, cases, CPT) are beyond the threshold of difference with recent actuals, detector 180 transmits a notification or an alert.

The anomalies may include shortage of transportation carriers, a number of empty segments exceeding a threshold, too many transportation carriers, etc. In some embodiments, detector 180 generates trends based on historic data to identify consistent problems or anomalies. In some embodiments, detector 180 compares performance of forecaster 102 to desired goals and provides adjustments to the routes as needed. In some embodiments, detector 180 is configured to provide adjustments and implement the adjustments by refreshing the routes with the adjustment.

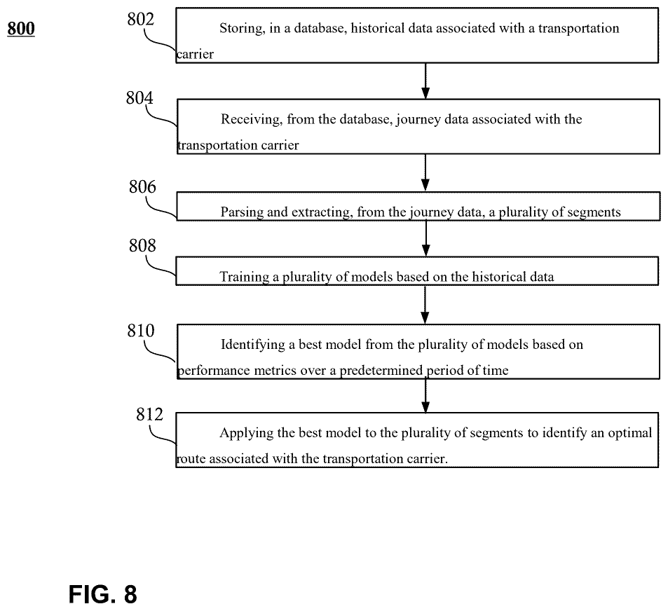

FIG. 8 is a flowchart illustrating an exemplary method for forecasting resource allocations. At operation 802, forecaster 102 stores historical data within database 116. Forecaster 102 may receive historical data from an electronic device or user interface associated with the user. The historical data may include route data, journey data, or other data associated with operation of a transportation carrier. At operation 804, forecaster 102 may receive from the database journey data associated with the transportation carrier. The journey data may be routes or transportation parameters associated with the transportation carrier. The transportation parameters may include distance travelled (e.g. miles driven), loads, length of hauls, number of chambers per route, amount of cargo or goods transported, etc. At operation 806, forecaster 102 may parse and extract a plurality of segments from the journey data. The plurality of segments may be segments of a journey undertaken by the transportation carrier. In some embodiments, the plurality of segments include one or more inbound segments, one or more outbound segments, and/or one or more empty segments.

At operation 808, forecaster 102 may be configured to train a plurality of models based on the historical data. Forecaster 102 may train the plurality of models in parallel over a predetermine training period. At operation 810, forecaster 102 may identify a best model from the plurality of models. The best model may be identified based on a plurality of performance metrics associated with each model over a predetermined period of time. At operation 812, forecaster 102 may apply the best model to the plurality of segments to generate a plurality of forecasted parameters and an optimal route. The plurality of forecasted parameters may be used to generate the optimal route.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

1. A system, comprising:
a database storing historical data associated with a transportation carrier;
a computing device comprising at least one processor in communication with the database, the computing device being configured to:
receive, from the database, journey data associated with the transportation carrier;
parse and extract, from the journey data, a plurality of segments including: an inbound segment, an outbound segment, and an empty segment;
train a plurality of machine learning models based on the historical data;
identify a best machine learning model from the plurality of machine learning models based on one or more performance metrics over a predetermined period of time; and
apply the best machine learning model to the plurality of segments to identify an optimal route associated with the transportation carrier from a plurality of candidate routes, wherein the optimal route has the least number of empty segments among the plurality of candidate routes.

2. (canceled)

3. The system of claim 1, wherein the empty segment is associated with the transportation carrier being devoid of goods.

4. The system of claim 1, wherein the processor is further configured to:
identify an origination point for each of segment of the plurality of segments.

5. The system of claim 1 wherein the processor is further configured to:
extract a route from the journey data; and
segment the route to identify the plurality of segments.

6. The system of claim 1 wherein the processor is further configured to:
train, in parallel, the plurality of machine learning models;
identify the best machine learning model of the plurality of machine learning models; and
use the best machine learning model to generate forecast parameters associated with the transportation carrier.

7. The system of claim 1 wherein the processor is further configured to:
detect an anomaly from the journey data based on comparing one or more forecasted parameters to a predetermined threshold; and
provide a recommended route adjustment based on the anomaly.

8. The system of claim 1 wherein the processor is further configured to:
train, in parallel, a plurality of adjustment models, the adjustment models configured to incorporate one or more adjustment factors;
identify a best adjustment model of the plurality of adjustment models; and
use the best adjustment model to generate adjusted forecast parameters associated with the transportation carrier during a specific period of time.

9. The system of claim 1 wherein the processor is further configured to:
apply a baseline fix to the best machine learning model to account for volatility.

10. The system of claim 1 wherein the processor is further configured to:
identify routes between a domicile of the transportation carrier and a first location; and
apply the best machine learning model to the historical data to identify a subset of the routes, the subset of the routes having minimized transportation distances between the domicile and the first location.

11. A method comprising:
storing, in a database, historical data associated with a transportation carrier;
receiving, from the database, journey data associated with the transportation carrier;
parsing and extracting, from the journey data, a plurality of segments including: an inbound segment, an outbound segment, and an empty segment;
training a plurality of machine learning models based on the historical data;
identifying a best machine learning model from the plurality of machine learning models based on one or more performance metrics over a predetermined period of time; and
applying the best machine learning model to the plurality of segments to identify an optimal route associated with the transportation carrier from a plurality of candidate routes, wherein the optimal route has the least number of empty segments among the plurality of candidate routes.

12. (canceled)

13. The method of claim 11, wherein the empty segment is associated with the transportation carrier being devoid of goods.

14. The method of claim 11 further comprising:
identifying an origination point for each of segment of the plurality of segments.

15. The method of claim 11 further comprising:
extracting a route from the journey data; and
segmenting the route to identify the plurality of segments.

16. The method of claim 11 further comprising:
training, in parallel, the plurality of machine learning models;
identifying the best machine learning model of the plurality of machine learning models; and
using the best machine learning model, generating forecast parameters associated with the transportation carrier.

17. The method of claim 11 further comprising:
detecting an anomaly from the journey data based on comparing one or more forecasted parameters to a predetermined threshold; and
providing a recommended route adjustment based on the anomaly.

18. The method of claim 11 further comprising:
training, in parallel, a plurality of adjustment models, the adjustment models configured to incorporate one or more adjustment factors;
identifying a best adjustment model of the plurality of adjustment models; and
using the best adjustment model, generating adjusted forecast parameters associated with the transportation carrier during a specific period of time.

19. The method of claim 11 further comprising:
identifying routes between a domicile of the transportation carrier and a first location; and
applying the best machine learning model to the historical data to identify a subset of the routes, the subset of the routes having minimized transportation distances between the domicile and the first location.

20. A non-transitory computer readable medium having instructions stored thereon, wherein the instructions, when executed by at least one processor, cause at least one device to perform operations comprising:
storing, in a database, historical data associated with a transportation carrier;
receiving, from the database, journey data associated with the transportation carrier;
parsing and extracting, from the journey data, a plurality of segments including: an inbound segment, an outbound segment, and an empty segment;
training a plurality of machine learning models based on the historical data;
identifying a best machine learning model from the plurality of machine learning models based on one or more performance metrics over a predetermined period of time; and
applying the best machine learning model to the plurality of segments to identify an optimal route associated with the transportation carrier from a plurality of candidate routes wherein the optimal route has the least number of empty segments among the plurality of candidate routes.
